(19) United States
(12) Patent Application Publication
(10) Pub. No.: US 2010/0149935 A1
(43) Pub. Date: Jun. 17, 2010

(54) Optical Disc Device

(76) Inventor: Tsuyoshi Katayama, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/089,167

(22) PCT Filed: Oct. 3, 2006
(86) PCT No.: PCT/JP2006/319808

§ 371 Date: Apr. 3, 2008

(30) Foreign Application Priority Data
Oct. 3, 2005 (JP) 2005-290284

(51) Int. Cl. G11B 20/10

(52) U.S. Cl. 369/47.14

(57) ABSTRACT

There is provided an optical disc device capable of recording and reproducing a DVD-RAM disc, which can perform a control with stability at a high speed without being affected by a CAPA component. The optical disc device comprises an error signal detection unit for detecting an error signal from a signal component obtained from an optical pickup, a filter for removing a specific frequency component included in the error signal, a holding unit for temporarily holding the error signal, a switching unit for switching the destination of the error signal to either the filter or the holding unit, a servo control unit for controlling the optical pickup by using the error signal outputted from the filter or the holding unit, and a controller for adaptively controlling the switching timing of the switching unit in accordance with the specific frequency component included in the error signal.

### TECHNICAL FIELD

The present invention relates to an optical disc device aimed at recording/playback of a DVD-RAM disk.

### BACKGROUND ART

With the progress of speed up and high densification in an optical disc device, an optical servo for maintaining a focal point of a laser beam on an information recording track has rapidly been required to improve its accuracy, and accuracy improvements have been performed for optical discs of various standards.

FIG. 8 is a diagram illustrating the construction of a conventional optical disc device 800 disclosed in Non-patent Document 1.

In FIG. 8, an optical disc 1 is a rewritable DVD-RAM disc as an example of an optical disc medium 1. An optical pickup 2 performs writing and reading of data in/from the optical disc medium 1, and it is provided with an objective lens, a focus actuator for focusing a light spot, and a tracking actuator (these elements are not shown).

A radial feeder 3 moves the optical pickup 2 in the radial direction of the optical disc 1. An error signal detector 4 detects an error signal such as a tracking error signal or a focus error signal on the basis of a light-reception signal that is read from the optical disc 1. A focus controller 5 drives the focus actuator mounted on the optical pickup 2 to perform a control for making the objective lens of the optical pickup 2 follow a surface fluctuation of the optical disc 1. A tracking controller 6 drives the tracking actuator mounted on the optical pickup 2 to perform a control for making the objective lens of the optical pickup 2 follow an eccentricity of the optical disc 1. A traverse controller 7 performs a drive control for the radial feeder 3.

A spindle controller 8 controls rotation of a disc motor. Reference numeral 9 denotes a disc motor for rotating the optical disc, and reference numeral 10 denotes a signal processor for processing the signal from the optical pickup.

In the optical disc device 800 constituted as described above, an error signal such as a focus error signal or a tracking error signal is detected by the error signal detector 4 on the basis of the optical signal read out by the optical pickup 2, and a focus control or a tracking control based on a feedback control using the detected error signal is performed by the focus controller 5 or the tracking controller 6, respectively, thereby realizing stable data recording/playback in the optical disc device.

Non-patent Document 1: Yoshiroh Ohotomo, “Optical Disc”, Maruzen, 1990

### DISCLOSURE OF THE INVENTION

### Problems to be Solved by the Invention

When the DVD-RAM disc is rotated at a high speed in the above-described optical disc device, servo performance of higher accuracy is required as compared with low-speed rotation. In this case, it is a major problem that a CAPA (Complimentary Allocated Pit Address) component which is an address area performing land/groove switching or the like is superposed as an unnecessary signal on the error signal obtained from the optical pickup. FIG. 9 shows an output signal from the light-receiving element of the optical pickup. In FIG. 9, the CAPA component is superposed on reflection light from the optical disc at timings of t1 and t2, and the CAPA component is superposed on the error signal if the error signal is generated based on this light-receiving signal.

Further, during performing data recording/playback, when the optical pickup reaches near the outermost circumference of the disc, there occurs a problem that a high-frequency component such as a partial surface fluctuation or a partial eccentricity of the disc might remain in the error signal, which is a phenomenon unique to high-speed rotation. As described above, it has been a major issue to perform a control stably and speedily when rotating a DVD-RAM disc at high speed.

The present invention is made to solve the above-described problems and has for its object to provide an optical disc device which can stably perform a servo control for an optical pickup without being affected by a CAPA component when a DVD-RAM disc is rotated at a high speed.

### Measures to Solve the Problems

In order to solve the above-described problems, an optical disc device according to claim 1 of the present invention includes an error signal detection unit for detecting an error signal from a signal component obtained from an optical pickup, a filter for removing a specific frequency component included in the error signal, a holding unit for temporarily holding the error signal, a switching unit for switching the destination of the error signal to either the filter or the holding unit, a servo control unit for controlling the optical pickup by using the error signal outputted from the filter or the holding unit, and a controller for controlling the switching of the switching unit on the basis of the specific frequency component.

Further, according to claim 2 of the present invention, the optical disc device defined in claim 1 further includes a jump judgment circuit for judging a focus jump operation and a track jump operation, and outputting a jump detection signal, and the controller controls the switching of the switching unit on the basis of the jump detection signal and the specific frequency component.

Further, according to claim 3 of the present invention, the optical disc device defined in claim 1 further includes a pull-in judgment circuit for judging a focus pull-in operation and a tracking pull-in operation, and outputting a pull-in detection signal, and the controller controls the switching of the switching unit on the basis of the pull-in detection signal and the specific frequency component.

Further, according to claim 4 of the present invention, the optical disc device defined in claim 1 further includes a seek operation detection circuit for judging a seek operation in a radial direction of a disc, and outputting a seek detection signal, and the controller controls the switching of the switching unit on the basis of the seek detection signal and the specific frequency component.

Further, according to claim 5 of the present invention, the optical disc device defined in claim 1 further includes an ON/OFF judgment circuit for judging ON/OFF of a tracking control operation, and outputting a tracking ON/OFF detection signal, and the controller controls the switching of the switching unit on the basis of the tracking ON/OFF detection signal and the specific frequency component.

Further, according to claim 6 of the present invention, the optical disc device defined in claim 1 includes a jump judgment circuit for judging a focus jump operation and a tracking jump operation, and outputting a jump detection signal, a pull-in judgment circuit for judging a focus pull-in operation and a tracking pull-in operation, and outputting a pull-in detection signal, a seek operation detection circuit for judging a seek operation in a radial direction of a disc, and outputting a seek detection signal, and a tracking ON/OFF judgment circuit for judging ON/OFF of a tracking control operation, and outputting a tracking ON/OFF detection signal, and the controller receives the jump detection signal, the pull-in detection signal, the seek detection signal, and the tracking ON/OFF detection signal, and appropriately controls the switching of the switching unit in accordance with the operating state of the optical disc device.

Further, an optical disc device according to claim 7 of the present invention comprises an error signal detection unit for detecting an error signal from a signal component obtained from an optical pickup, a filter for removing a specific frequency component included in the error signal, a holding unit for temporarily holding the error signal, a servo control unit for controlling the optical pickup by using the error signal outputted from the filter or the holding unit, a switching unit for switching the destination of the error signal outputted from the filter to either the servo control filter or the holding unit, and a controller for controlling the switching of the switching unit on the basis of the specific frequency component.

### EFFECTS OF THE INVENTION

An optical disc device according to claim 1 of the present invention includes an error signal detection unit for detecting an error signal from a signal component obtained from an optical pickup, a filter for removing a specific frequency component included in the error signal, a holding unit for temporarily holding the error signal, a switching unit for switching the destination of the error signal to either the filter or the holding unit, a servo control unit for controlling the optical pickup by using the error signal outputted from the filter or the holding unit, and a controller for controlling the switching of the switching unit on the basis of the specific frequency component. Therefore, by removing a specific frequency component in a DVD-RAM disc with using the filter for removing leak-in of a CAPA component, the CAPA component which is increased in frequency during high-speed operation is prevented from being superposed on the error signal. Further, arbitrary switching between the filter for removing the leak-in of the CAPA component and the hold circuit for temporarily holding the error signal can be performed by the selector switch, thereby stably performing the focus/tracking control without being affected by the CAPA component even when performing high-speed recording/playback.

Further, according to claim 2 of the present invention, the optical disc device defined in claim 1 further includes a jump judgment circuit for judging a focus jump operation and a track jump operation, and outputting a jump detection signal, and the controller controls the switching of the switching unit on the basis of the jump detection signal and the specific frequency component. Therefore, when performing the focus jump operation or the track jump operation, arbitrary switching between the filter for removing leak-in of the CAPA component and the hold circuit for temporarily holding the error signal can be performed using the selector switch, thereby stably performing the control for the focus/track jump operation without being affected by the CAPA component even when performing high-speed recording/playback.

Further, according to claim 3 of the present invention, the optical disc device defined in claim 1 further includes a pull-in judgment circuit for judging a focus pull-in operation and a tracking pull-in operation, and outputting a pull-in detection signal, and the controller controls the switching of the switching unit on the basis of the pull-in detection signal and the specific frequency component. Therefore, when performing the focus pull-in operation or the tracking pull-in operation, arbitrary switching between the filter for removing leak-in of the CAPA component and the hold circuit for temporarily holding the error signal can be performed using the selector switch, thereby stably performing the control for the focus/tracking pull-in operation without being affected by the CAPA component even when performing high-speed recording/playback.

Further, according to claim 4 of the present invention, the optical disc device defined in claim 1 further includes a seek operation detection circuit for judging a seek operation in a radial direction of a disc, and outputting a seek detection signal, and the controller controls the switching of the switching unit on the basis of the seek detection signal and the specific frequency component. Therefore, when performing the seek operation, arbitrary switching between the filter for removing leak-in of the CAPA component and the hold circuit for temporarily holding the error signal can be performed using the selector switch, thereby stably performing the seek operation without being affected by the CAPA component even when performing high-speed recording/playback.

Further, according to claim 5 of the present invention, the optical disc device defined in claim 1 further includes an ON/OFF judgment circuit for judging ON/OFF of a tracking control operation, and outputting a tracking ON/OFF detection signal, and the controller controls the switching of the switching unit on the basis of the tracking ON/OFF detection signal and the specific frequency component. Therefore, the focus/tracking control is performed via the CAPA removal filter selected by the selector switch when the tracking is ON while the hold operation for temporarily holding the error signal can be selected by the selector switch when the tracking is OFF, thereby stably performing the tracking ON/OFF operation without being affected by the CAPA component.

Further, according to claim 6 of the present invention, the optical disc device defined in claim 1 includes a jump judgment circuit for judging a focus jump operation and a tracking jump operation, and outputting a jump detection signal, a pull-in judgment circuit for judging a focus pull-in operation and a tracking pull-in operation, and outputting a pull-in detection signal, a seek operation detection circuit for judging a seek operation in a radial direction of a disc, and outputting a seek detection signal, and a tracking ON/OFF judgment circuit for judging ON/OFF of a tracking control operation, and outputting a tracking ON/OFF detection signal, and the controller receives the jump detection signal, the pull-in detection signal, the seek detection signal, and the tracking ON/OFF detection signal to appropriately control the switching of the switching unit in accordance with the operating state of the optical disc device. Therefore, arbitrary switching between the filter for removing leak-in of the CAPA component and the hold circuit for temporarily holding the error signal can be performed in accordance with the operating state of the optical disc device, thereby enhancing the stability of the operation of the optical disc device during high-speed recording/playback.

Further, an optical disc device according to claim 7 of the present invention comprises an error signal detection unit for detecting an error signal from a signal component obtained from an optical pickup, a filter for removing a specific frequency component included in the error signal, a holding unit for temporarily holding the error signal, a servo control unit for controlling the optical pickup by using the error signal outputted from the filter or the holding unit, a switching unit for switching the destination of the error signal outputted from the filter to either the servo control filter or the holding unit, and a controller for controlling the switching of the switching unit on the basis of the specific frequency component. Therefore, the CAPA component can be removed from the error signal, thereby enabling correspondence to speed-up of the optical disc device.

### BRIEF DESCRIPTION OF THE DRAWINGS

FIG. 1 is a block diagram of an optical disc device according to a first embodiment of the present invention.

FIG. 2 is a block diagram of an optical disc device according to a second embodiment of the present invention.

FIG. 3 is a block diagram of an optical disc device according to a third embodiment of the present invention.

FIG. 4 is a block diagram of an optical disc device according to a fourth embodiment of the present invention.

FIG. 5 is a block diagram of an optical disc device according to a fifth embodiment of the present invention.

FIG. 6 is a block diagram of an optical disc device according to a sixth embodiment of the present invention.

FIG. 7 is a block diagram of an optical disc device according to a seventh embodiment of the present invention.

FIG. 8 is a block diagram illustrating the construction of the conventional optical disc device.

FIG. 9 is a diagram illustrating a light-reception signal on which a CAPA component is superposed.

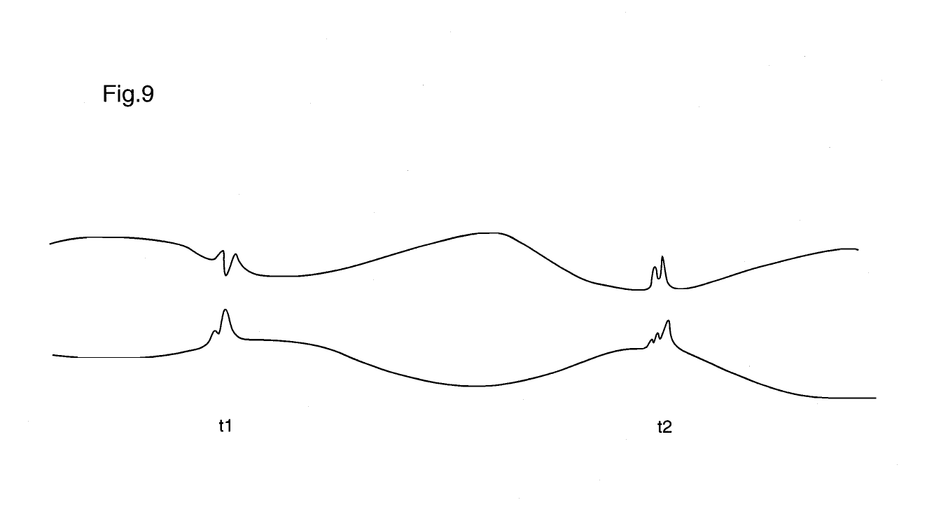

### DESCRIPTION OF REFERENCE NUMERALS

1 . . . optical disc
2 . . . optical pickup
3 . . . radial feeder
4 . . . error signal detector
5 . . . focus controller
6 . . . tracking controller
7 . . . traverse controller
8 . . . spindle controller
9 . . . disc motor
10 . . . signal processor
11 . . . CAPA removal filter
12 . . . hold circuit
13 . . . selector switch
14 . . . controller
15 . . . jump judgment circuit
16 . . . pull-in judgment circuit
17 . . . seek operation detection circuit
18 . . . tracking ON/OFF judgment circuit

### BEST MODE TO EXECUTE THE INVENTION

### Embodiment 1

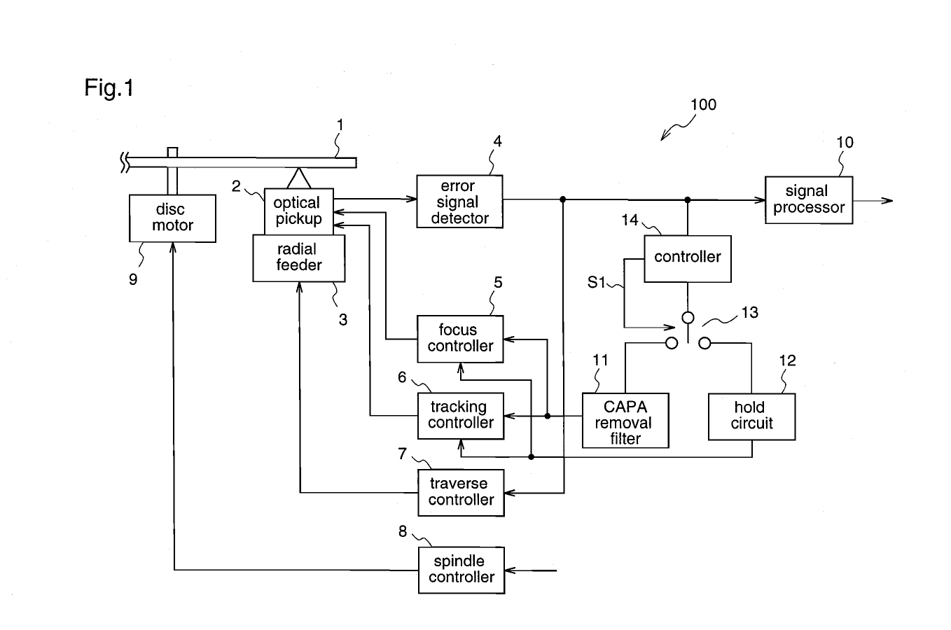

FIG. 1 is a diagram illustrating the construction of an optical disc device 100 according to a first embodiment.

In FIG. 1, the optical disc device 100 includes an optical pickup 2 for applying a light spot on a predetermined position of the optical disc 1, a radial feeder 3 for moving the optical pickup 2 in the radial direction of the optical disc 1, and an error signal detector 4 for generating an error signal such as a tracking error signal or a focus error signal on the basis of a light-receiving signal outputted from the optical pickup 2. In this first embodiment, a DVD-RAM disc is used as the optical disc 1.

Further, the optical disc device 100 includes a focus controller 5 for driving a focus actuator mounted on the optical pickup 2 to perform a control for making an objective lens of the optical pickup 2 follow a surface vibration of the optical disc 1, a tracking controller 6 for driving a tracking actuator mounted on the optical pickup 2 to perform a control for making the objective lens of the optical pickup 2 follow an eccentricity of the optical disc 1, a traverse controller 7 for controlling driving of the radial feeder 3, a spindle controller 8 for controlling rotation of a disc motor 9, a disc motor 9 for rotating the optical disc 1 at a predetermined rpm, and a signal processor 10 for processing the light-receiving signal outputted from the optical pickup 2 to convert the signal into an audio signal or a video signal.

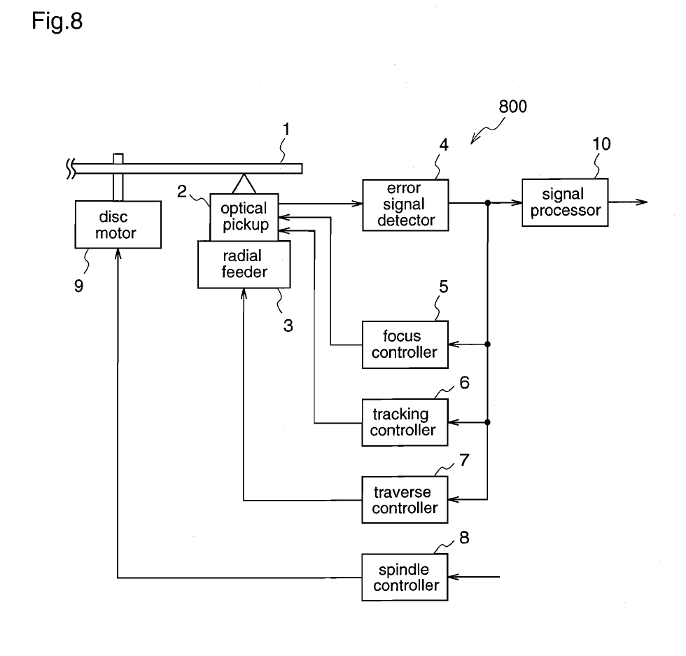

These constituents are identical to those of the conventional optical disc device 800 described above, and the same reference numerals as those shown in FIG. 8 are used.

Furthermore, the optical disc device 100 includes a CAPA removal filter 11, a hold circuit 12, a selector switch 13, and a controller 14.

The CAPA removal filter 11 removes a CAPA component which is included in an error signal detected by the error signal detector 4, and it is a low-pass filter on which a cut-off frequency that can remove the CAPA component is set.

The hold circuit 12 holds the error signal for an arbitrary period of time, and outputs the value of the error signal. To be specific, the hold circuit 12 holds a just previous value which is not affected by the CAPA component during a period in which the CAPA component is detected, and outputs the value, thereby outputting the error signal which is not affected by the CAPA component.

The selector switch 13 selects either of the CAPA removal filter 11 or the hold circuit 12 as a destination of the error signal detected by the error signal detector 4.

The controller 14 detects the frequency of the CAPA component superposed on the error signal, and determines as to whether the CAPA component should be avoided by using the hold circuit 12 or the CAPA component should be removed by using the CAPA removal filter 11 according to the characteristics of the CAPA component, and changes the connection of the selector switch 13.

To be specific, when the frequency of the detected CAPA component exceeds a frequency that is predetermined in relation to the operation state of the optical disc device 100, the controller 14 judges that the influence of the CAPA component cannot be completely avoided, and outputs a switching instruction signal S1 which controls the selector switch 13 to be switched to the CAPA removal filter 11 side. The switching timing of the selector switch 13 by the controller 14 can be arbitrarily set on the basis of the operation speck of the optical disc device or the influence of the CAPA component on the operating state of the optical disc device.

Next, the operation of the optical disc device 100 constituted as described above will be described.

When an optical signal is read out from the optical disc 1 by the optical pickup 2, an error signal as a signal to be compensated in the optical disc device is detected by the error signal detector 4. When a tracking error signal is output as the error signal from the error signal detector 4, the tracking error signal is input to the controller 14.

When normal recording or playback is carried out, i.e., when the tracking operation is ON, the selector switch 13 is connected to the hold circuit 12 under control of the controller 14, and the tracking error signal inputted to the controller 14 is supplied to the hold circuit 12 via the selector switch 13.

When the optical pickup 2 is positioned in the land/groove area, the error signal inputted to the hold circuit 12 is output to the tracking controller 6. Thereafter, when the optical pickup 2 comes to the CAPA area on the optical disc 1, a signal area that is not affected by the CAPA component is held by the hold circuit 12 and output to the tracking controller 6. In the tracking controller 6, tracking control is performed using the tracking error signal. Further, in the case of performing recording/playback of a DVD-RAM disc at a high speed, when the disc has a physically unbalanced CAPA and thereby an offset remains or when the track center deviates when the optical spot passes the CAPA area, a tracking error signal that is not affected by the CAPA component is held by the hold circuit 12 and output to the tracking controller 6.

Then, in the tracking controller 6, tracking control for the optical pickup 2 is carried out in accordance with the tracking error signal.

On the other hand, when the recording/playback speed of the optical disc 1 is increased, the CAPA component is increased in frequency with an increase in the rpm of the optical disc 1, and the influence of the CAPA component cannot be ignored if the optical disc device is in a specific operating state such as a jump operation or a seek operation, resulting in the case where it is desired that the CAPA component is surely removed. Further, when the recording/playback is performed at a high speed, the frequency of the CAPA component is increased, and the operation of the control system such as detection of the CAPA period or holding/outputting of the just-previous signal cannot catch up with the CAPA component even if it is tried to avoid the CAPA component using the hold circuit 12, resulting in the case where the CAPA component cannot be completely avoided.

As described above, when the controller 14 judges that the influence of the CAPA component on the optical disc device 100 cannot be avoided, the controller 14 outputs a switching instruction signal S1 which instructs the selector switch 13 to select the CAPA removal filter 11.

When the connection of the switch 13 is changed to the CAPA removal filter 11 side, the tracking error signal is input to the CAPA removal filter 11, and the CAPA component is removed from the tracking error signal by the CAPA removal filter 11, and then the tracking error signal is output to the tracking controller 6. Then, tracking control for the optical pickup 2 is performed by the tracking controller on the basis of the tracking error signal outputted from the CAPA removal filter 11.

As described above, the optical disc device according to the first embodiment is provided with the CAPA removal filter for removing the CAPA component superposed on the error signal, the hold circuit for holding the error signal during an arbitrary period of time, the selector switch for switching the destination of the error signal between the CAPA removal filter and the hold circuit, and the controller for controlling the selector switch, and it is selected according to the CAPA component superposed on the error signal as to whether the CAPA component should be removed using the CAPA removal filter or the CAPA component should be avoided using the hold circuit. Therefore, even when the CAPA component which is increased in frequency is superposed on the error signal, the tracking control for the optical pickup can be performed using the tracking error signal that is not affected by the CAPA component, thereby realizing high-speed and stable recording/playback operation when using the DVD-RAM disc.

While in this first embodiment the tracking control has been described as an example, the present invention is not restricted thereto, and it is possible also in focus control to remove a CAPA component included in a focus error signal.

### Embodiment 2

An optical disc device according to a second embodiment of the present invention further includes a circuit for detecting a jump operation in the optical disc device in addition to the constituents of the optical disc device 100 of the first embodiment, and control for the selector switch 13 during the jump operation is performed based on a CAPA component superposed on an error signal, thereby realizing a stable jump operation.

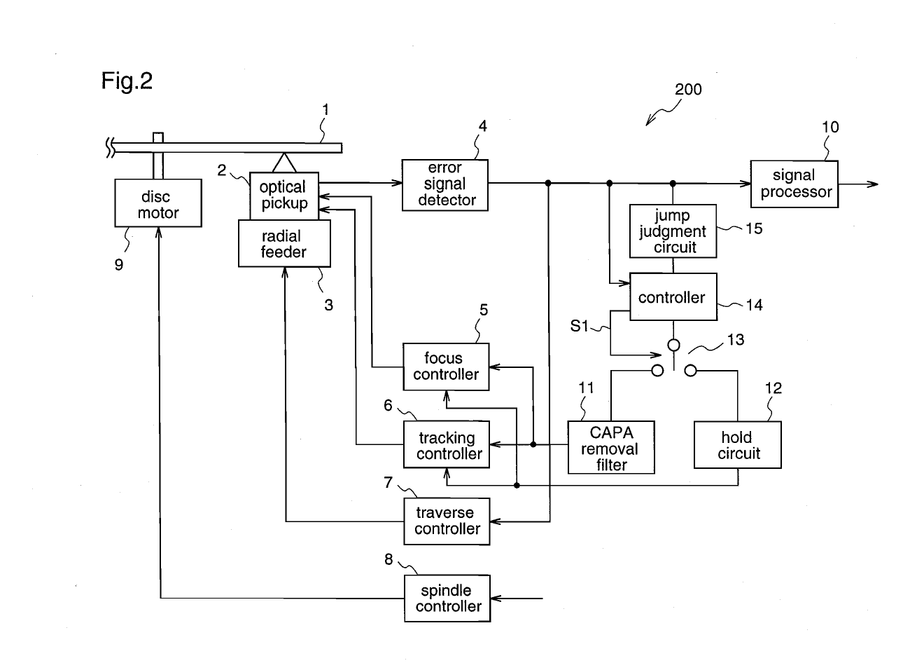

FIG. 2 is a diagram illustrating the construction of the optical disc device according to the second embodiment of the present invention. In FIG. 2, the same constituents as those shown in FIG. 1 are given the same reference numerals to omit description thereof.

With reference to FIG. 2, a jump judgement circuit 15 detects a jump pulse that is superposed on an error signal to detect that a track jump operation or a focus jump operation has been performed in the optical disc device 200, and outputs a jump operation detection signal.

The controller 14 according to the second embodiment receives the jump operation detection signal, and performs a control for the selector switch 13 during the jump operation on the basis of a CAPA component detected from the error signal.

To be specific, as the result of the detection for the frequency of the CAPA component superposed on the tracking error signal, when the controller 14 judges that the influence of the CAPA component on the track jump operation is non-negligibly large, i.e., when the detected frequency of the CAPA component exceeds a frequency that is predetermined in relation to the influence of the CAPA component on the track jump operation, the controller 14 switches the selector switch 13 to the CAPA removal filter 11 side. Further, also when the operation of the control system such as detection of the CAPA period or holding/outputting of the just-previous signal cannot catch up with the CAPA component even if the controller 14 tries to avoid the CAPA component using the hold circuit 12 according to the result of the detection of the CAPA component and therefore the controller 14 judges that the CAPA component cannot be completely avoided, the controller 14 switches the selector switch 13 to the CAPA removal filter 11 side.

Next, the operation of the optical disc device 200 constituted as described above will be described.

When the optical disc 1 is loaded on the optical disc device 200 and recording or playback operation is started, an optical signal is read out from the optical disc 1, and a tracking error signal is detected in the error signal detector 4.

During normal recording/playback operation, when the selector switch 13 is connected to the hold circuit 12 under control of the controller 14, the tracking error signal inputted to the controller 14 is supplied to the hold circuit 12 through the selector switch 13. When the optical pickup 2 is positioned in the land/groove area, the error signal inputted to the hold circuit 12 is output to the tracking controller 6. Thereafter, when the optical pickup 2 comes to the CAPA area on the optical disc 1, a signal area that is not affected by the CAPA component is held by the hold circuit 12, and output to the tracking controller 6. The tracking controller 6 performs tracking control using the tracking error signal.

When a track jump operation is performed during the recording/playback operation of the optical disc device, the jump judgement circuit 14 detects the jump operation, and outputs a jump operation detection signal to the controller 14.

When the jump operation detection signal is input to the controller 14, the controller 14 judges whether the CAPA component should be avoided using the hold circuit 12 or the CAPA component should be removed using the CAPA removal filter 11 under the track jump operation. When the controller 14 judges that the influence of the CAPA component cannot be avoided, the controller 14 outputs a switching instruction signal S1 which instructs the selector switch 13 to select the CAPA removal filter 11.

When the connection of the selector switch 13 is switched to the CAPA removal filter 11 side, the tracking error signal is input to the CAPA removal filter 11, and the CAPA component is removed by the CAPA removal filter 11, and then the tracking error signal is output to the tracking controller 6. Then, the tracking controller 6 performs control using the tracking error signal.

As described above, the optical disc device according to the second embodiment is provided with the CAPA removal filter for removing a CAPA component superposed on an error signal, the hold circuit for holding the error signal for an arbitrary period, the selector switch for switching the destination of the error signal between the CAPA removal filter and the hold circuit, the controller for controlling the selector switch, and the jump judgment circuit for detecting the jump operation of the optical disc device, and the selector switch is switched to the CAPA removal filter side when it is judged that the influence of the CAPA component cannot be avoided during the jump operation. Therefore, stable jump operation can be performed without being affected by the CAPA component.

While in this second embodiment the operation during the tracking jump operation has been described as an example, the present invention is not restricted thereto, and it is possible to remove a CAPA component included in a focus error signal even during a focus jump operation.

### Embodiment 3

An optical disc device according to a third embodiment of the present invention is provided with a circuit for detecting a servo pull-in operation of the optical disc device in addition to the constituents of the optical disc device 100 of the first embodiment, and control for the selector switch 13 during the servo pull-in operation is performed based on a CAPA component superposed on an error signal, thereby realizing stable servo pull-in operation.

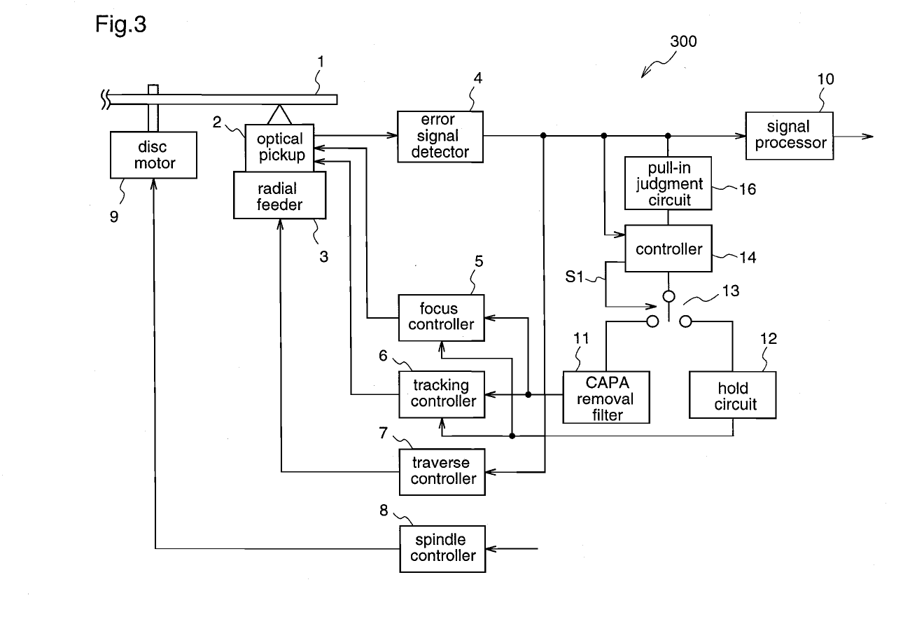

Hereinafter, the optical disc device according to the third embodiment will be described with reference to FIG. 3. In FIG. 3, the same constituents as those shown in FIG. 1 are given the same reference numerals to omit description thereof.

In FIG. 3, a pull-in judgment circuit 16 detects that a track pull-in operation has been performed on the basis of the error signal, and outputs a pull-in detection signal to the controller 14.

The controller 14 according to the third embodiment receives the pull-in detection signal, and performs a control for the selector switch 13 during the tracking pull-in operation on the basis of the CAPA component superposed on the error signal.

To be specific, the controller 14 detects the CAPA component superposed on the tracking error signal. As the result, when the controller 14 judges that the influence of the CAPA component on the track pull-in operation is non-negligibly large, i.e., when the frequency of the detected CAPA component exceeds a frequency that is predetermined in relation to the influence on the tracking pull-in operation, the controller 14 switches the selector switch 13 to the CAPA removal filter 11 side. Further, also when the controller 14 judges that the CAPA component cannot be completely avoided because the operation of the control system such as detection of the CAPA period or holding/output of the previous signal cannot catch up with the CAPA component even if the controller 14 tries to avoid the CAPA component using the hold circuit 12 according to the result of the detection of the CAPA component, the controller 14 switches the selector switch 13 to the CAPA removal filter 11 side.

Next, the operation of the optical disc device 300 constituted as described above will be described.

When the optical disc 1 is loaded on the optical disc device 300 and recording or playback operation is started, an optical signal is read out from the optical disc 1, and a tracking error signal is detected in the error signal detector 4.

During the normal recording/playback operation, when the selector switch 13 is connected to the hold circuit 12 under control of the controller 14, the tracking error signal inputted to the controller 14 is supplied to the hold circuit 12 through the selector switch 13. When the optical pickup 2 is located in the land/groove area, the error signal inputted to the hold signal 12 is output to the tracking controller 6, and the error signal inputted to the hold circuit 12 is output to the tracking controller 6. Thereafter, when the optical pickup 2 comes to the CAPA area on the optical disc 1, a signal region that is not affected by the CAPA component is held by the hold circuit 12, and output to the tracking controller 6. The tracking controller 6, performs tracking control using the tracking error signal.

If a track pull-in operation is performed during the recording/playback operation of the optical disc device, the pull-in judgment circuit 16 detects the track pull-in operation, and outputs a pull-in detection signal to the controller 14.

When the pull-in detection signal is input to the controller 14, the controller 14 judges whether the CAPA component should be avoided using the hold circuit 12 or the CAPA component should be removed using the CAPA removal filter 11, under the tracking pull-in operation. When the controller 14 judges that the influence of the CAPA component cannot be avoided, the controller 14 outputs a switching instruction signal S1 which instructs the selector switch 13 to select the CAPA removal filter 11.

When the connection of the selector switch 13 is switched to the CAPA removal filter 11, the tracking error signal is input to the CAPA removal filter 11, and the CAPA component is removed by the CAPA removal filter 11, and then the tracking error signal is output to the tracking controller 6. Then, the tracking controller 6 performs control using the tracking error signal.

As described above, the optical disc device according to the third embodiment is provided with the CAPA removal filter for removing the CAPA component superposed on the error signal, the hold circuit for holding the error signal for an arbitrary period of time, the selector switch for switching the destination of the error signal between the CAPA removal filter and the hold circuit, the controller for controlling the selector switch, and the pull-in judgment circuit for detecting a tracking pull-in operation of the optical disc device, and the selector switch is switched to the CAPA removal filter side when it is judged that the influence of the CAPA component cannot be avoided during the tracking pull-in operation. Therefore, stable tracking pull-in operation can be performed without being affected by the CAPA component.

While in this third embodiment the operation during the tracking pull-in operation has been described as an example, the present invention is not restricted thereto, and it is also possible to remove a CAPA component included in a focus error signal during a focus pull-in operation.

### Embodiment 4

An optical disc device according to a fourth embodiment of the present invention is provided with a circuit for detecting a seek operation of the optical disc device in addition to the constituents of the optical disc device 100 of the first embodiment, and control of the selector switch 13 during the seek operation is carried out based on a CAPA component superposed on an error signal, thereby realizing a stable seek operation.

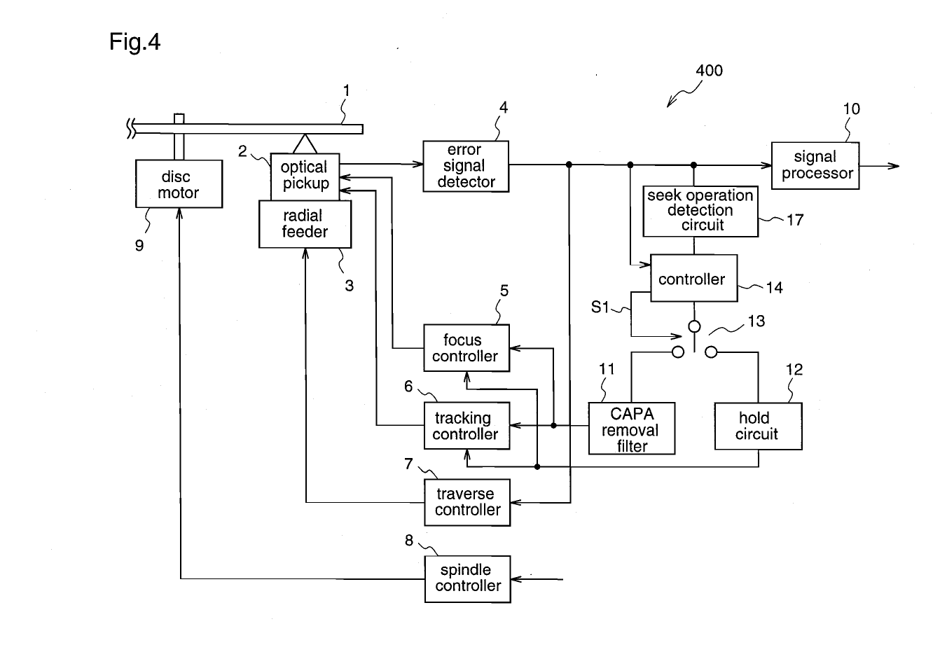

Hereinafter, the optical disc device according to the fourth embodiment will be described with reference to FIG. 4. In FIG. 4, the same constituents as those shown in FIG. 1 are given the same reference numerals to omit description thereof.

In FIG. 4, a seek operation detection circuit 17 detects that a seek operation has been performed on the basis of the error signal, and outputs a seek operation detection signal to the controller 14.

The controller 14 according to the fourth embodiment receives the seek detection signal, and judges whether the CAPA component should be avoided using the hold circuit 12 or the CAPA component should be removed using the CAPA removal filter 11 under the seek operation, according to the CAPA component included in the tracking error signal, and changes the connection of the selector switch 13.

To be specific, when the controller 14 detects the CAPA component superposed on the tracking error signal, and consequently, judges that the influence of the CAPA component on the seek operation is non-negligibly large, i.e., when the frequency of the detected CAPA component exceeds a frequency that is predetermined in relation to the influence on the tracking pull-in operation, the controller 14 switches the selector switch 13 to the CAPA removal filter 11 side. Further, also when the controller 14 judges based on the result of the detection of the CAPA component that the control by the hold circuit 12 cannot catch up with the CAPA component, the controller 14 switches the selector switch 13 to the CAPA removal filter 11 side.

Next, the operation of the optical disc device 400 constituted as described above will be described.

When the optical disc 1 is loaded on the optical disc device 400 and recording or playback operation is started, an optical signal is read out from the optical disc 1, and a tracking error signal is detected in the error signal detector 4.

During the normal recording/playback operation, when the selector switch 13 is connected to the hold circuit 12 under control of the controller 14, the tracking error signal inputted to the controller 14 is supplied to the hold circuit 12 through the selector switch 13. When the optical pickup 2 is located in the land/groove area, the error signal inputted to the hold signal 12 is output to the tracking controller 6, and the error signal inputted to the hold circuit 12 is output to the tracking controller 6. Thereafter, when the optical pickup 2 comes to the CAPA area on the optical disc 1, a signal region that is not affected by the CAPA component is held by the hold circuit 12, and output to the tracking controller 6. The tracking controller 6 performs tracking control using the tracking error signal.

If a seek operation is performed in the radial direction of the optical disc 1 during the recording/playback operation of the optical disc device, the seek operation detection circuit 17 detects that the seek operation has been performed, and outputs a seek operation detection signal to the controller 14.

When the seek operation detection signal is input to the controller 14, the controller 14 judges whether the CAPA component should be avoided using the hold circuit 12 or the CAPA component should be removed using the CAPA removal filter 11 under the seek operation. When the controller 14 judges that the influence of the CAPA component cannot be avoided, the controller 14 outputs a switching instruction signal S1 which instructs the selector switch 13 to select the CAPA removal filter 11.

When the connection of the selector switch 13 is switched to the CAPA removal filter 11 side, the tracking error signal is input to the CAPA removal filter 11, and the CAPA component is removed by the CAPA removal filter 11, and then the tracking error signal is output to the tracking controller 6. Then, the tracking controller 6 performs control using the tracking error signal.

As described above, the optical disc device according to the fourth embodiment is provided with the CAPA removal filter for removing the CAPA component superposed on the error signal, the hold circuit for holding the error signal for an arbitrary period, the selector switch for switching the destination of the error signal between the CAPA removal filter and the hold circuit, the controller for controlling the selector switch, and the seek operation detection circuit for detecting a seek operation of the optical disc device, and the selector switch is switched to the CAPA removal filter side when it is judged that the influence of the CAPA component cannot be avoided during the seek operation. Therefore, stable seek operation can be performed without being affected by the CAPA component.

### Embodiment 5

An optical disc device according to a fifth embodiment of the present invention is obtained by adding a circuit for detecting ON/OFF of tracking control operation of the optical disc device to the optical disc device 100 according to the first embodiment, and the selector switch is controlled independently of the ON/OFF of the tracking operation, thereby realizing stable ON/OFF of the tracking control operation.

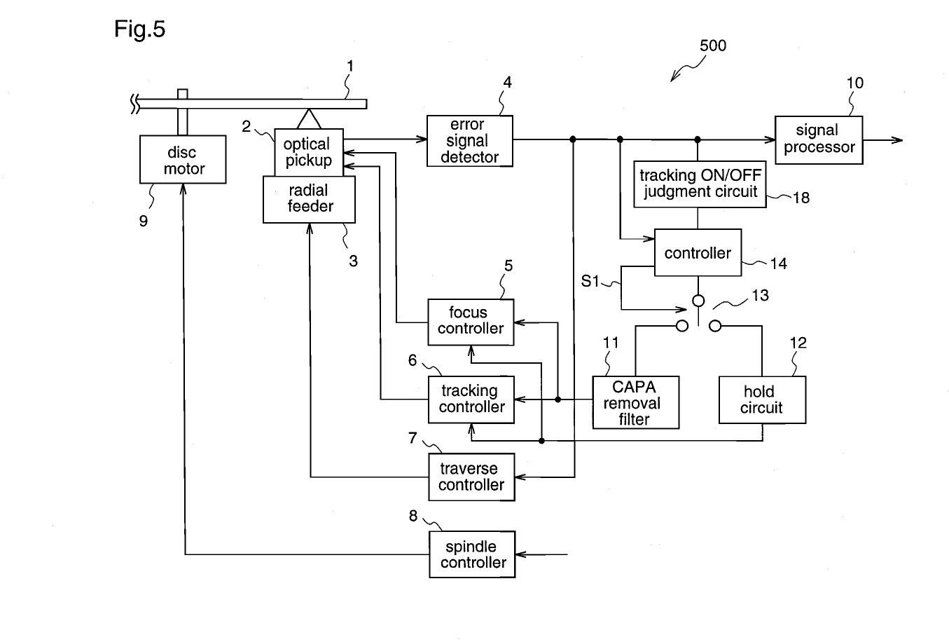

Hereinafter, the optical disc device according to the fifth embodiment will be described with reference to FIG. 5. In FIG. 5, the same constituents as those shown in FIG. 1 are given the same reference numerals to omit the description thereof.

In FIG. 5, the tracking ON/OFF judgment is to judge ON/OFF of the tracking control operation in the optical disc device on the basis of the error signal outputted from the error signal detector 4.

Next, the operation will be described.

In the case where the optical disc 1 is loaded on the optical disc device 500 and a recording or playback operation is performed, the tracking control is ON when the recording operation is performed from the inner circumference of the optical disc 1 toward the outer circumference thereof, and usually, when the normal tracking control is ON, the controller 14 switches the selector switch 13 to the hold circuit 12 side to turn on the hold operation.

In the case where a tracking control loop is opened for gain learning of an error signal even though the tracking control is ON, if the hold circuit 12 is used, the characteristic of the inspection signal based on the error signal undesirably changes, and therefore, the hold circuit 12 cannot be used practically. In this case, even though the tracking control is ON, the selector switch 13 is switched to the CAPA removal filter 11 side by the controller 14.

When the selector switch 13 is switched to the CAPA removal filter 11 side, the tracking error signal is input to the CAPA removal filter 11, and the CAPA component is removed. Thereafter, the tracking error signal is output to the tracking controller 6, and tracking ON/OFF operation is performed under control of the tracking controller 6.

When performing a track jump operation, tracking control is usually OFF while focus control is ON. In this case, the hold circuit 12 is fundamentally used in its OFF state. However, even in this case, the controller 14 performs control such that the connection of the selector switch 13 is appropriately switched between the hold circuit 12 and the CAPA removal filter 11 according the CAPA component that is included in the error signal outputted from the error signal detector 4.

As described above, the optical disc device according to the fifth embodiment is provided with the CAPA removal filter for removing a CAPA component superposed on an error signal, the hold circuit for holding the error signal for a predetermined period, the selector switch for switching the destination of the error signal between the CAPA removal filter and the hold circuit, and the tracking ON/OFF judgment circuit for judging ON/OFF of the tracking control operation. Therefore, even in the state where the use of the hold circuit 12 is restricted by ON/OFF of the tracking control, the selector switch 13 can be switched to the CAPA removal filter 11 side, thereby stably performing the tracking ON/OFF operation while avoiding the influence of the CAPA component superposed on the error signal.

### Embodiment 6

An optical disc device according to a sixth embodiment is obtained by providing the optical disc device 100 according to the first embodiment with the jump judgment circuit 15, the pull-in judgment circuit 16, the seek operation detection circuit 17, and the tracking ON/OFF judgment circuit 18 which are described for the second to fifth embodiments, thereby performing switching between the hold circuit 12 and the CAPA removal filter 11 during various operations in the optical disc device, resulting in stable servo control.

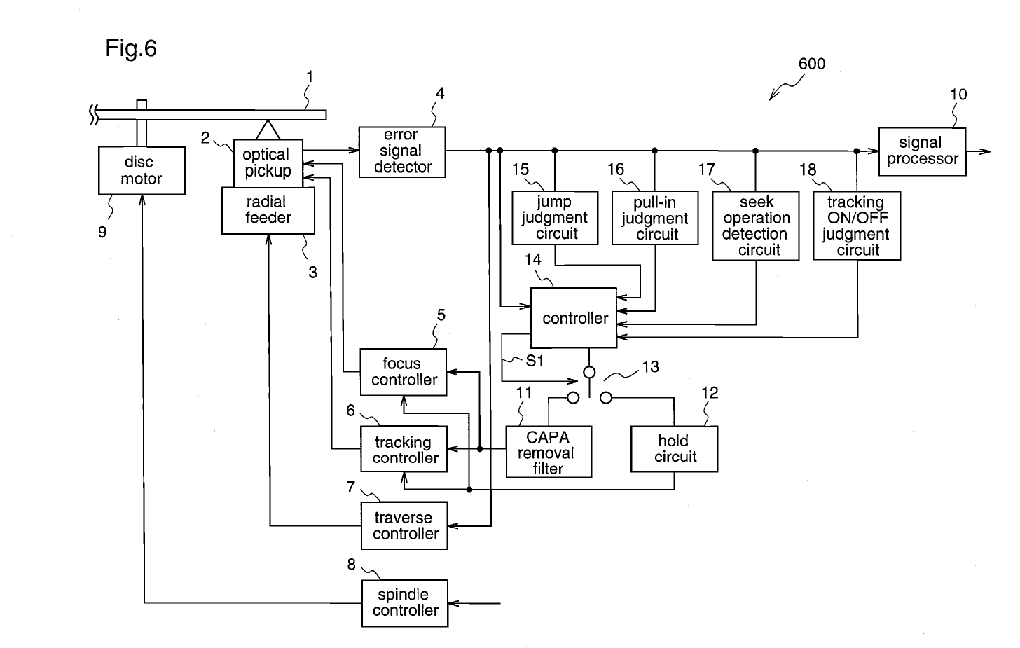

Hereinafter, the optical disc device according to the sixth embodiment will be described with reference to FIG. 6.

In the optical disc device 600 according to the sixth embodiment, as shown in FIG. 6, the jump judgment circuit 15, the pull-in judgment circuit 16, the seek operation detection circuit 17, and the tracking ON/OFF judgment circuit 18 are connected in parallel with each other as shown in FIG. 6.

Next, the operation will be described.

When the optical disc 1 is loaded on the optical disc device 600 and recording or playback operation is performed, an optical signal is read out from the optical disc 1, and an error signal is detected in the error signal detector 4. The tracking error signal is input to the controller 14, the jump judgment circuit 15, the pull-in judgment circuit 16, the seek operation detection circuit 17, and the tracking ON/OFF judgment circuit 18.

When the selector switch 13 is connected to the hold circuit 12 side under control of the controller 14 during the normal recording/playback operation, the tracking error signal inputted to the controller 14 is supplied to the hold circuit 12 through the selector switch 13. When the optical pickup 2 is located in the land/groove area, the error signal inputted to the hold circuit 12 is output to the tracking controller 6. Thereafter, when the optical pickup 2 comes to the CAPA area on the optical disc 1, a signal region that is not affected by the CAPA component is held by the hold circuit 12 and output to the tracking controller 6. The tracking controller 6 performs tracking control using the tracking error signal.

When a track jump operation is performed in the optical disc device 600, the jump judgment circuit 15 detects that the track jump operation has been performed, and outputs a jump operation detection signal to the controller 14.

When the jump operation detection signal is input to the controller 14, the controller 14 judges whether the CAPA component should be avoided using the hold circuit 12 or the CAPA component should be removed using the CAPA removal filter 11, according to the CAPA component included in the tracking error signal.

The controller 14 switches the selector switch 13 to the hold circuit 12 side during the normal track jump operation to avoid the CAPA component using the hold circuit 12. However, when the controller 14 judges that the CAPA component is unavoidable as the result of the detection of the CAPA component included in the tracking error signal, the controller 14 switches the selector switch 13 to the CAPA removal filter 11 side.

When the connection of the selector switch 13 is switched to the CAPA removal filter 11 side, the tracking error signal is input to the CAPA removal filter 11, and the CAPA component is removed by the CAPA removal filter 11, and then the tracking error signal is output to the tracking controller 6. Then, a track jump operation is performed under control of the tracking controller 6.

Further, when performing the tracking pull-in operation that follows the track jump operation, the pull-in judgment circuit 16 detects the pull-in timing, and outputs a pull-in detection signal to the controller 14.

When the pull-in detection signal is input to the controller 14, the controller 14 judges whether the CAPA component should be avoided using the hold circuit 12 or the CAPA component should be removed using the CAPA removal filter 11 during the tracking pull-in operation, according to the CAPA component included in the tracking error signal. For example, when performing the tracking pull-in operation, if the influence of the CAPA component on the tracking pull-in operation is non-negligibly large, the selector switch 13 is switched to the CAPA removal filter 11 side.

When the connection of the selector switch 13 is switched to the CAPA removal filter 11 side, the tracking error signal is input to the CAPA removal filter 11, and the CAPA component is removed by the CAPA removal filter 11, and then the tracking error signal is output to the tracking controller 6. Then, the tracking controller 6 performs control using the tracking error signal.

As described above, in the respective operations of the optical disc device 600, the controller 14 judges whether the CAPA component should be removed using the CAPA removal filter 11 or the CAPA component should be avoided using the hold circuit 12, according to the CAPA component included in the tracking error signal, and performs switching control for the input signal to the tracking controller 6.

As described above, according to the optical disc device of the sixth embodiment, the controller adaptively controls the selector switch 13 in accordance with the detection signals of the respective operations which are outputted from the jump judgment circuit 15, the pull-in judgment circuit 16, the seek operation detection circuit 17, and the tracking ON/OFF judgment circuit 18, and the CAPA component included in the tracking error signal. Therefore, switching between the CAPA removal filter and the hold circuit can be performed according to the various operation states of the optical disc device, thereby realizing stable operation of the optical disc device without being affected by the CAPA component.

While in this sixth embodiment the case where a track jump operation is performed during recording/playback is described as an example, the present invention is not restricted thereto. Even in the case where a seek operation is performed during recording/playback in the optical disc device 600, the controller 14 can control the ON/OFF of tracking control as well as the switching of the selector switch 13 during a tracking pull-in operation, as in the case of the above-mentioned track jump operation, thereby realizing a stable operation of the optical disc device 600.

### Embodiment 7

An optical disc device 700 according to a seventh embodiment of the present invention is constituted such that, in the optical disc device 600 according to the sixth embodiment, a CAPA component superposed on an error signal is constantly removed using the CAPA removal filter 11, and the CAPA component is avoided using an arbitrary hold circuit 12 according to the CAPA component that remains in the error signal.

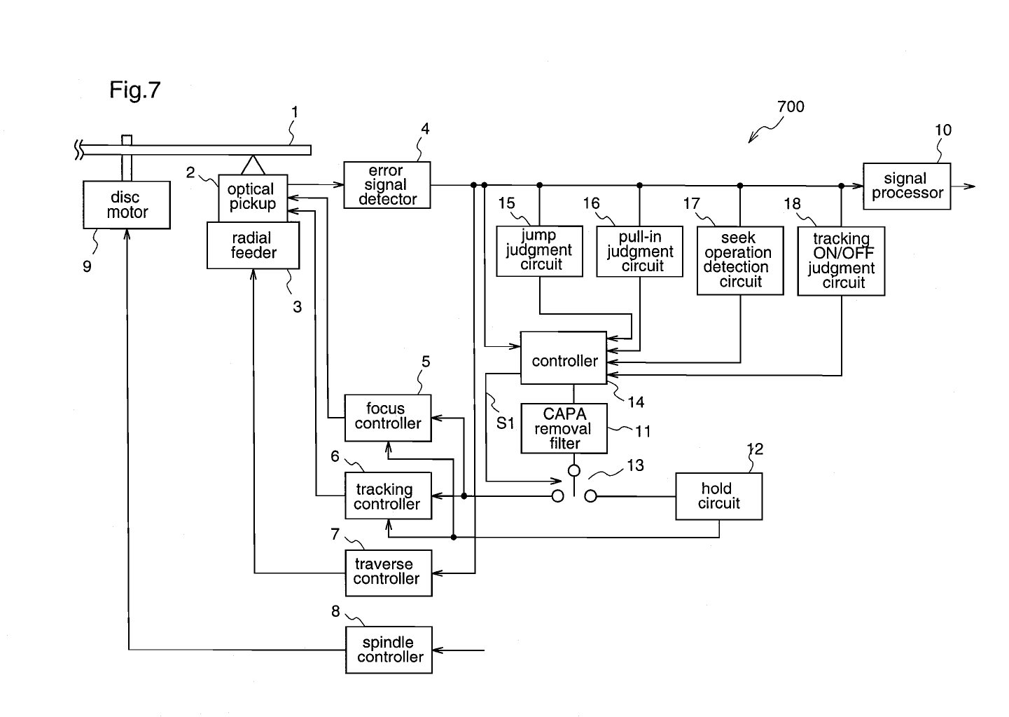

FIG. 7 is a diagram illustrating the construction of the optical disc device 700 according to the seventh embodiment. In FIG. 7, the same constituents as those of the optical disc device 600 according to the sixth embodiment are given the same reference numerals to omit the description thereof.

With reference to FIG. 7, in the optical disc device 700 according to the seventh embodiment, the error signal outputted from the jump judgment circuit 15, the pull-in judgment circuit 16, the seek operation detection circuit 17, or the tracking ON/OFF judgment circuit 18 is directly input to the CAPA removal filter 11, and the error signal from which the CAPA component is removed by the CAPA removal filter 11 is input to the focus controller 5 and to either of the tracking control circuit 6 or the hold circuit 12 via the selector switch 13.

The controller 14 detects the residual CAPA component that remains in the error signal after passing through the CAPA removal filter 11, and controls the selector switch 13 according to the residual CAPA component included in the error signal.

Next, the operation of the optical disc device 700 constituted as described above will be described.

When the optical disc 1 is loaded on the optical disc device 700 and recording or playback operation is performed, an optical signal is read out from the optical disc 1, and an error signal is detected in the error signal detector 4. When a tracking error signal is detected as the error signal, the tracking error signal is input to the controller 14, the jump judgment circuit 15, the pull-in judgment circuit 16, the seek operation detection circuit 17, and the tracking ON/OFF judgment circuit 18, respectively.

During the normal recording/playback operation, the selector switch 13 is controlled to be connected to the tracking controller 6 by the controller 14, and the tracking error signal inputted to the controller 14 is directly supplied to the tracking controller 6 through the CAPA removal filter 11. Then, the tracking controller 6 performs tracking control based on the tracking error signal.

When a track jump operation is performed during the recording/playback operation of the optical disc device 700, the jump judgment circuit 14 detects the jump operation, and outputs a jump operation detection signal to the controller 14. When the jump operation detection signal is input to the controller 14, the controller 14 judges whether the residual CAPA component should be avoided using the hold circuit 12, under the track jump operation. When the controller 14 judges that the influence of the residual CAPA component on the track jump operation is non-negligibly large, the selector switch 13 is switched to the hold circuit 12 side.

When the connection of the selector switch 13 is changed, the tracking error signal is input to the tracking controller 6 via the hold circuit 12. At this time, when the optical pickup 2 comes to the CAPA area on the optical disc 1, a signal region that is not affected by the residual CAPA component is held by the hold circuit 12 and output to the tracking controller 6. Then, the tracking controller 6 performs a control using the tracking error signal.

As described above, according to the optical disc device of the seventh embodiment, the CAPA component included in the error signal is previously removed using the CAPA removal filter, and it is determined whether the CAPA component should be avoided using the hold circuit or the error signal should be directly output to the servo control system, according to the residual CAPA component included in the error signal. Therefore, even when the recording/playback operation of the optical disc device is fixed to a high speed, the servo control can be performed using the error signal that is not affected by the CAPA component, thereby stably performing the recording/playback operation using the DVD-RAM disc.

### APPLICABILITY IN INDUSTRY

According to an optical disc device of the present invention, it is possible to appropriately select whether a CAPA component should be removed using a CAPA removal filter or the CAPA component should be avoided using a hold circuit under control of a controller, thereby enhancing stability and followability of focus/tracking control during high-speed operation of a DVD-RAM disc in the optical disc device.

1. An optical disc device comprising:
an error signal detection unit for detecting an error signal from a signal component obtained from an optical pickup;
a filter for removing a specific frequency component included in the error signal;
a holding unit for temporarily holding the error signal;
a switching unit for switching the destination of the error signal to either the filter or the holding unit;
a servo control unit for controlling the optical pickup by using the error signal outputted from the filter or the holding unit; and
a controller for controlling the switching of the switching unit on the basis of the specific frequency component.

2. An optical disc device as defined in claim 1 further including:
a jump judgment circuit for judging a focus jump operation and a track jump operation, and outputting a jump detection signal; and
said controller controlling the switching of the switching unit on the basis of the jump detection signal and the specific frequency component.

3. An optical disc device as defined in claim 1 further including:
a pull-in judgment circuit for judging a focus pull-in operation and a tracking pull-in operation, and outputting a pull-in detection signal; and
said controller controlling the switching of the switching unit on the basis of the pull-in detection signal and the specific frequency component.

4. An optical disc device as defined in claim 1 further including a seek operation detection circuit for judging a seek operation in a radial direction of a disc, and outputting a seek detection signal; and
said controller controlling the switching of the switching unit on the basis of the seek detection signal and the specific frequency component.

5. An optical disc device as defined in claim 1 further including an ON/OFF judgment circuit for judging ON/OFF of a tracking control operation, and outputting a tracking ON/OFF detection signal; and
said controller controlling the switching of the switching unit on the basis of the tracking ON/OFF detection signal and the specific frequency component.

6. An optical disc device as defined in claim 1 including:
a jump judgment circuit for judging a focus jump operation and a tracking jump operation, and outputting a jump detection signal;
a pull-in judgment circuit for judging a focus pull-in operation and a tracking pull-in operation, and outputting a pull-in detection signal;
a seek operation detection circuit for judging a seek operation in a radial direction of a disc, and outputting a seek detection signal; and
a tracking ON/OFF judgment circuit for judging ON/OFF of a tracking control operation, and outputting a tracking ON/OFF detection signal; and
said controller receiving the jump detection signal, the pull-in detection signal, the seek detection signal, and the tracking ON/OFF detection signal, and appropriately controlling the switching of the switching unit in accordance with the operating state of the optical disc device.

7. An optical disc device comprising:
an error signal detection unit for detecting an error signal from a signal component obtained from an optical pickup;
a filter for removing a specific frequency component included in the error signal;
a holding unit for temporarily holding the error signal;
a servo control unit for controlling the optical pickup by using the error signal outputted from the filter or the holding unit;
a switching unit for switching the destination of the error signal outputted from the filter to either the servo control filter or the holding unit; and
a controller for controlling the switching of the switching unit on the basis of the specific frequency component.
